(19) United States
(12) Patent Application Publication
(10) Pub. No.: US 2017/0017635 A1
(43) Pub. Date: Jan. 19, 2017

(54) NATURAL LANGUAGE PROCESSING SYSTEM AND METHOD

(71) Applicant: Fido Labs Inc., Palo Alto, CA (US)

(72) Inventors: GNIEWOSZ LELIWA, Gdansk (PL); Michal Wroczynski, Gdynia (PL)

(73) Assignee: Fido Labs Inc., Palo Alto, CA (US)

(21) Appl. No.: 15/213,117

(22) Filed: Jul. 18, 2016

Related U.S. Application Data
(60) Provisional application No. 62/193,943, filed on Jul. 17, 2015.

(51) Int. Cl. G06F 17/27

(52) U.S. Cl. CPC G06F 17/271; G06F 17/2765; G06F 17/274; G06F 17/2785; G06F 17/2735; G06F 17/2795

(57) ABSTRACT

Embodiments of a system and method for natural language processing (NLP) utilize one or more extraction models, and an output of syntactic parser applied to a text to extract information from the text. In an embodiment, an extraction model defines one or more units or combinations of units within a grammar hierarchy (a word, a phase, a clause, or any combination of words, phrases and clauses) as an output of extraction process. An extraction model further comprises a set of rules where each rule sets one or more constraints on: a grammar structure output by extraction process; on the context of the output of extraction process; and on the relations between the output and the context.

### RELATED APPLICATIONS

This application claims the benefit of U.S. Provisional Patent Application No. 62/193,943, filed Jul. 17, 2015, which is incorporated by reference herein in its entirety. This application is also related to U.S. patent application Ser. No. 14/071,631, filed Nov. 4, 2013, now U.S. Pat. No. 9,152,632, issued Oct. 6, 2015, which is incorporated by reference herein in its entirety

### FIELD OF THE INVENTION

Inventions disclosed and claimed herein are in the field of natural language processing (NLP).

### BACKGROUND OF THE INVENTION

Current methods of getting actionable insights (and answers) out of text data rely strongly on classification (categorization). It means that for a set of text data, a set of categories is predefined. The task of classification systems is to sort data into those predefined categories.

Classification can be performed in a statistical or symbolic way. Statistical approach means that part of given text data is labeled according to predefined categories, and then machine or deep learning algorithms are used to train a model from a training data set. Symbolic approach means that decision is made based on a set of rules and knowledge.

Both approaches have a common downside: a set of categories needs to be predefined. For example, one can divide product reviews into two categories:

a) reviews that contain reported product issues;

b) reviews that do not contain reported product issues.

This analysis can tell how many of all reviews contain reported issues, but cannot further define the issues. To get deeper analysis and get to know which types of issues are reported, one needs to build a new classification model and predefine possible issue types, e.g.:

a) reviews with functionality issues;

b) reviews with stability issues;

c) reviews with feature requests;

d) reviews with feature removals;

e) reviews with complaints about additional costs.

The model needs to be built using rules or trained using labeled training data set. Now it can show statistical distribution of different types of issues in a given sample. But it cannot show anything that was not predefined, e.g. issues regarding user interface. Furthermore, a category can turn out to be too general, e.g. stability issues can be divided by device type or it can be valuable to know if a product crashes only on start or just randomly. Adding new category or dividing old ones always requires rebuilding the model. A single review can contain several issues reported. Generally, the more categories, the lower accuracy is achieved.

Furthermore, each approach (statistical and symbolic) has its own limitations. Statistical approach requires large enough labeled training data set. Especially deep learning is known to be extremely data-hungry. A trained model is a black box—it is impossible to say why certain decision was made. A trained model can be improved only by retraining on better data set (either corrected or larger). Symbolic approach needs rules and knowledge, and they both have to come from somewhere. Very often rules and knowledge in symbolic systems and hand coded. Relying on keywords and regular expressions, which is still the most popular rule-based approach, makes a model almost impossible to maintain and scale.

Both approaches require therefore manual labor. It can be either building rules or labeling data set. Crowdsourcing itself is not considered here as a separate method because it is not automatic. Although it is often used as a method for labeling data for statistical approaches. In a very simplified way, according to available resources, there are preferred approaches for building a classifier:

a) big domain knowledge, almost no labeled data—rule-based classifier;

b) medium domain knowledge, medium labeled data set—various machine learning classifier with feature engineering;

c) almost no domain knowledge, big labeled data set—deep learning classifier.

Most of specific everyday NLP tasks are not repetitive enough to put valuable resources into labeling data set that will be large enough to train accurate deep learning model. Because of that, repetitive but specific problems cannot be solved using deep learning. The situation is even worse for internal and sensitive data, where crowdsourcing is not an option. Sometimes internal data labeling creates useful training data set, but most often companies still rely on simple keyword patterns in their everyday NLP tasks.

There are some successful attempts to unsupervised learning, without labeling of data. Vectorization of words and phrases is a good example of a very successful attempt. Word embedding is a process of mapping words (or phrases in phrase embedding) from the vocabulary to vectors of real numbers. The word embedding tools take a text corpus as input, construct a vocabulary from training text data, learn vector representation of words and deliver the word vectors as output. Basically, this approach is based on the following hypothesis: words that appear in similar contexts have similar meaning. Vector representation allows to perform vector operations such as finding shortest distance between words (e.g. “France” is very close to “Spain” or “Belgium”) or arithmetic operations (e.g. “king−man+woman” is very close to “queen”). Vectorization is a relatively new and powerful approach that can automatically provide very useful knowledge to other NLP systems and therefore allow using supervised learning with much less labeled data to train accurate models. It can enrich current methods of getting actionable answers from text data in the same way as syntactic parsers enrich these methods by unveiling grammar dependencies between words and phrases. Alas, it cannot provide actionable answers by itself.

Another attempt to automatic extraction of answers from text data is Open Information Extraction, which aims to structure plain text in a reductionist form of relational triplets, such that the schema for these relations does not need to be specified in advance. However, this method has had very limited use in real-world applications and can only be used to answer very basic questions (e.g. Facebook's Memory Network trained to answer questions about a “cribbed” version of “Lord of the Rings”). This is because humans do not communicate in triplets and answering real-world questions require context, whereas this approach forces to get rid of it.

Accordingly, there is a need for an improved information extraction method that does not require predefinition of every possible, with the result of only obtaining a statistical view of known phenomena. It would be desirable to have a NLP system and method that can use output of the system to discover new phenomena in text. Moreover, it would be desirable for this method to be applicable at scale for any specific circumstances, no matter how repetitive, yet requiring as little manual labor as possible. Finally, it would be desirable to have a method that is not reliant on training and labeling of data in order to be effectively applicable to internal and sensitive enterprise data.

### BRIEF DESCRIPTION OF THE DRAWINGS

FIG. 1 is a block diagram of a natural language processing environment according to an embodiment.

FIG. 2 is a diagram illustrating a model extracting recommendations from a vertical (mobile applications).

FIG. 3 is a diagram illustrating a model extracting recommendations from a vertical (venues).

FIG. 4 is a block diagram illustrating an extraction process according to an embodiment.

FIG. 5 is a diagram illustrating a process of building an extraction model by assembling reusable definitions from a library.

FIG. 6 is a diagram illustrating a process of assembling definitions from a library in order to build an extraction model.

FIG. 7 is a flow diagram illustrating a process of building an extraction model for a new question.

FIG. 8 is is a diagram illustrating an output of an extraction model built for an application for the pharmaceutical industry.

FIG. 9 is a diagram illustrating an output of an extraction model built for an analytics application.

FIG. 10 is a diagram illustrating an output of an extraction model built for a hospitality and travel application.

### DETAILED DESCRIPTION OF THE INVENTION

The present invention provides a system and method for extracting information based on a decoded grammar structure of given text data, e.g. reviews, tweets, comments, blog posts, formal documents, emails, call center logs, customer service logs, doctor-patient notes. In an embodiment, a Language Decoder (LD) module is used to provide syntactic analysis of a text. The LD output structure consists of 3 levels of a grammar hierarchy: words, phrases and clauses with named types and directed relations among levels and between them. However, this method and system will effectively operate with any syntactic parser whose output structure can be translated into similar hierarchical structure with directed relations.

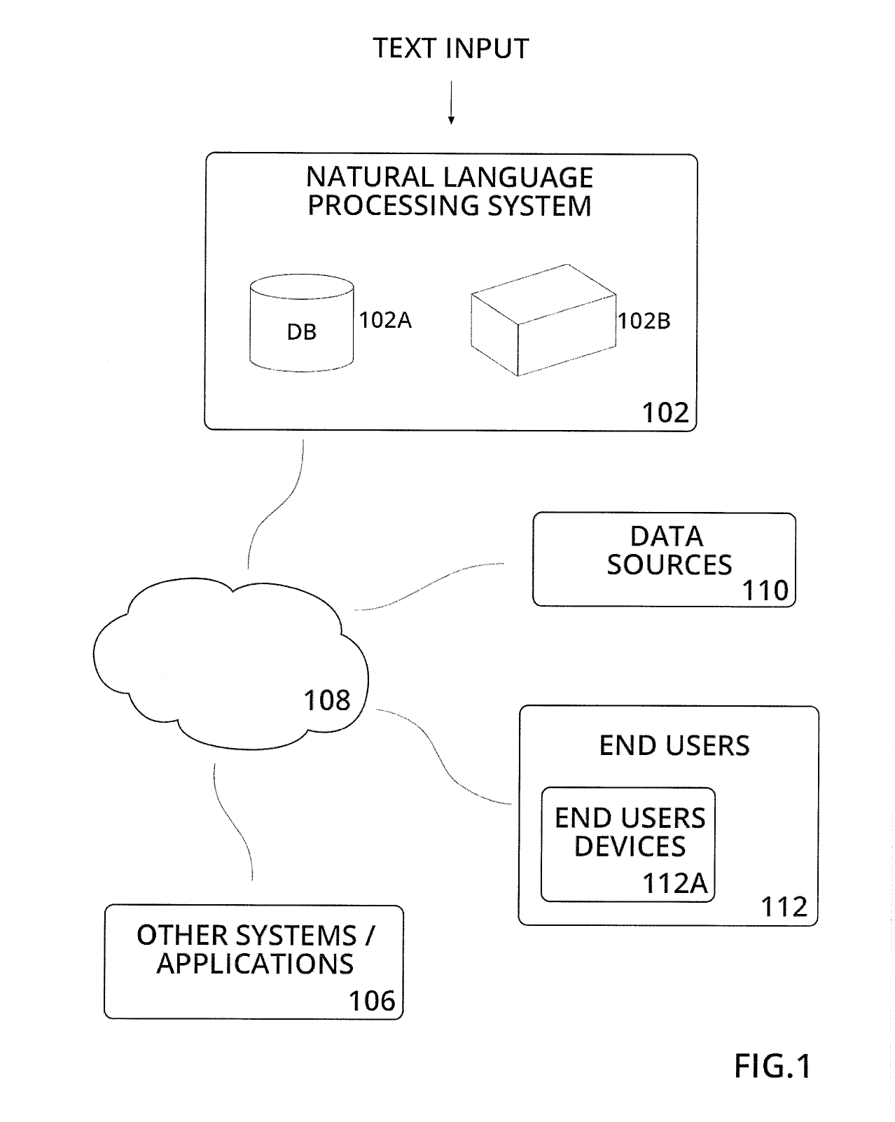

FIG. 1 is a block diagram of a natural language processing environment 100 according to an embodiment. A natural language processing (NLP) system 100 accepts text as input. Text can include electronic data from many sources, such as the Internet, physical media (e.g. hard disc), a network connected data base, etc. The NLP system 100 includes multiple databases 102A and multiple processors 102B. Processors 102B execute multiple methods as described herein. Databases 102A and processors 102B can be located anywhere that is accessible to a connected network 108, which is typically the Internet. Databases 102A and processors 102B can also be distributed geographically in the known manner. Data sources 210 include: 1) any source of electronic data that could serve as a source of text input to NLP system 102, and 2) any source of electronic data that could be searched using methods as further described below.

Other systems and applications 106 are systems, including commercial systems and associated software applications that have the capability to access and use the output of the NLP system 102 through one or more application programming interface (APIs) as further described below. For example, other systems/applications 106 can include an online application offering its users a search engine for answering specific queries. End users 112 include individuals who might use applications 106 through one or more of end user devices 112A. User devices 112A include without limitations personal computers, smart phones, tablet computers, and so on. In some embodiments, end users 112 access NLP system 102 directly through one or more APIs presented by NLP system 102.

The system and method utilizes extraction models to extract information from text. An extraction model defines a unit or a combination of units within a grammar hierarchy (e.g. a phase, a combination of phrases or a combination of phrases and clauses) as an output of extraction process. An extraction model is a set of rules where every single rule sets some constraints on the grammar structure, i.e. on the output of extraction process, on the context of the output of extraction process, and on the relations between the output and the context. The context consists of all units and combinations of units within a grammar hierarchy other than the output of extraction process, and all relations between these units and combinations of units. The rules comprising an extraction model are connected by logical operators such as AND, OR, XOR, NOT, or a combination of logical operators (e.g. AND NOT), which determine logical relations between constraints.

The task of an extraction model is to extract a part of text data that fulfill all of given constraints, where given constraints jointly reflect a set of grammar constructions used for expressing specific intents and experiences, e.g. reasons for doing something, recommendations, problems, requests. In an embodiment, an extraction model is a set of formal rules connected by logical operators that describes all possible ways of expressing a specific intent or experience in order to extract a unit or a combination of units within a grammar hierarchy representing this intent or experience. In other words, an extraction model extracts answers for a given question.

For example, a question “what people are afraid of” can be seen as an extraction model coded using the system and method disclosed herein. Extracted answers are part of text data where people write about their fears. The system and method allow to translate how people express the experience of being afraid of something into set of rules (constraints) that reflect grammar constructions used to express this experience. An exemplary set of these expressions:
am/are/was/ . . . afraid/frightened/scared/petrified/terrified/ . . . of/ . . . X;
X scares/terrifies/petrifies/ . . . me/us;
X is/are/ . . . scary/creepy/spooky/terrifying/a terrifying ordeal/ . . . ;
X send/sends/ . . . shivers down my/our spine/spines;
X make/makes/ . . . the hairs on the back of my/our neck/necks stand up.

In above example, X is the output of extraction process, e.g. a word, a phrase, a clause or a combination of them. The method and system disclosed herein allow to abstract these expressions, translate them into a set of rules comprising an extraction model, and execute the model to automatically extract answers (X in example) from any text data. In contrast to classification methods, the system and method disclosed herein allow to extract information without predefining possible outputs.

An exemplary set of rules can be an arbitrary implementation of following exemplary constraints (in this example the output of extraction process is defined as a phrase):
type of searched phrase must be “attribute”;
phrase X (additional variable) must exist;
phrase X cannot be searched phrase;
type of phrase X must be “preposition”;
searched phrase must be dependent to phrase X;
phrase X must consist of one of following words (“for”, “to”);
clause Y that is dependent to searched phrase (additional variable) cannot exist.

In above example, “searched phase” comprises the output of the extraction, whereas “phrase X” and “clause Y” comprises a part of the context of the output of extraction process. Rules containing “searched phrase” and “phrase X” or “clause Y” define required relations between the output of extraction process and the context of the output of extraction process.

The output of extraction process can consist of a unit or a combination of units within a grammar hierarchy, or multiple units or combinations of units within a grammar hierarchy, or none of them. The latter case can take place for binary classification, e.g. an extraction model can return a label (e.g. “true”) if all constraints are fulfilled and another label (e.g. “false”) otherwise.

An exemplary case of the output consisting of predefined labels instead of units or combinations of units within a grammar hierarchy:
a binary classifier that returns “true” if a given text contains a reported issue and “false” otherwise.

An exemplary case of extracting a unit or a combination of units:
an extraction model that extracts an object that someone is afraid of (X, e.g. clowns).

Exemplary cases of extracting multiple units or combinations of units:
an extraction model that extracts a place of departure (X, e.g. San Francisco) and a place of arrival (Y, e.g. New York) from text data;
an extraction model that extracts an action of doing something (X, e.g. deleting an app) and a reason related to this action (Y, e.g. constant ads).

In an embodiment, a result of executing an extraction model on a set of text data is provided as a database table with fixed number of columns related to number of units or combinations of units comprising the output of extraction process, where each row comprises the output of extraction process.

In an embodiment, Language Decoder Query Language (LDQL) is used as a system and method (query language) for building and executing extraction models. However, the method and system disclosed herein will effectively operate with any system and method that allow to define the output of extraction process and set constraints on the output of extraction process, on the context of the output of extraction process, and on the relations between the output and the context, and to execute these rules in order to extract the defined output.

The system and method disclosed herein rely on grammar structure as a foundation for setting constraints on the output of extraction process, on the context of the output of extraction process, and on the relations between the output and the context. However, in other embodiments, other logical or linguistic attributes derived from any other sources can be used as an addition to the process of setting constraints. These attributes includes (but not limited to):
semantic parameters derived from dictionaries, ontologies, thesauruses, semantic role labeling systems, named entity recognition systems, etc.;
lists of words (e.g. list on synonyms or antonyms) including any form of word normalization (e.g. lemmatization, stemming);
positions of words, phrases and clauses;
distances between words, phrases and clauses;
any statistical relations derived from text corpus such as collocation and co-occurrence.

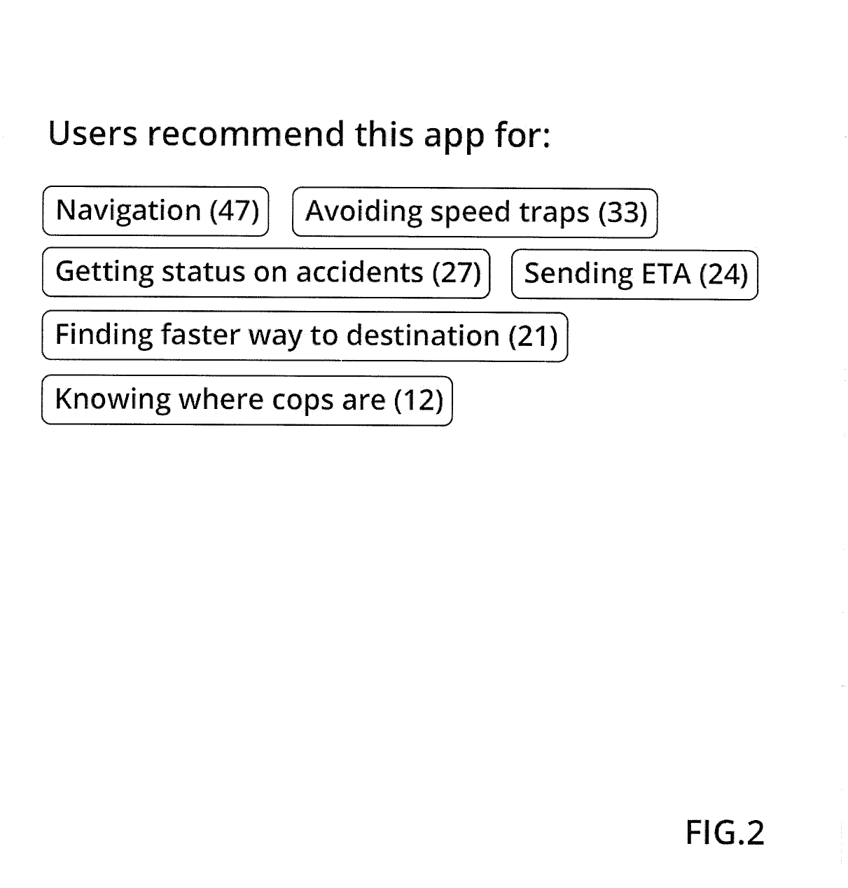

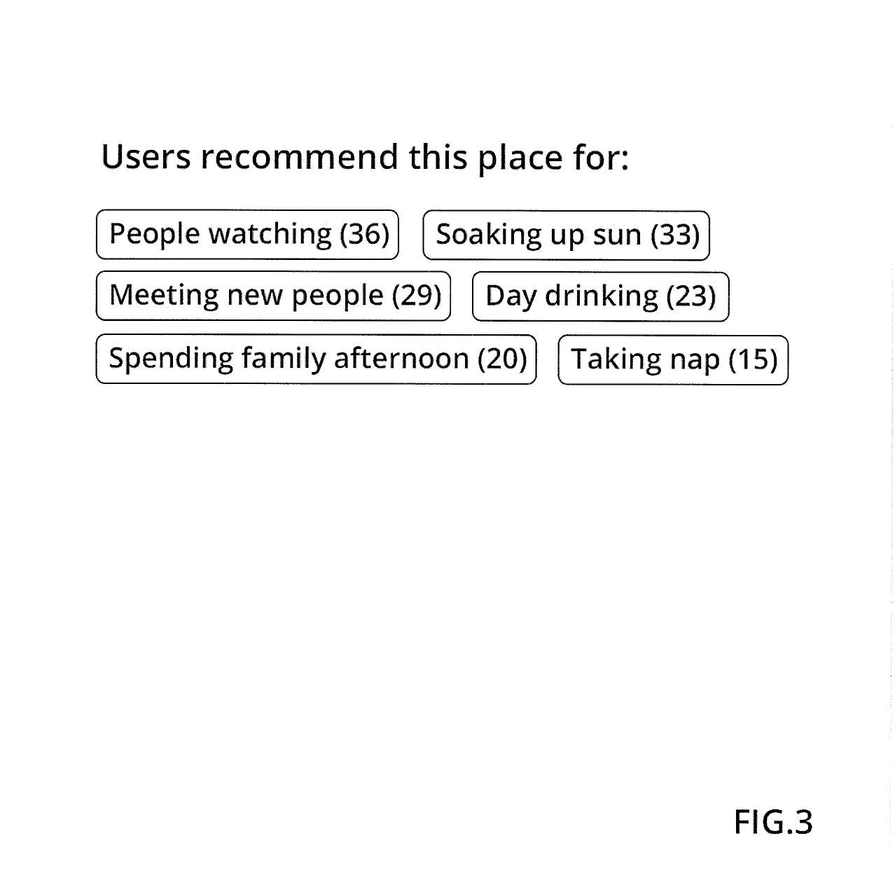

An extraction model, once coded, comprises a fully-automated way of extracting answers for a given question from text data. Furthermore, as grammar structure is a foundation for building rules, most of rules are reusable across a number of sources, domains and verticals and can be applied to many sources, domains and verticals with minor adjustments or even without any adjustment. For example, a model that extracts recommendations (e.g. for whom/what is something recommended) is instantly applicable to any products and services (e.g. mobile applications, cars, electronics, hotels, restaurants, professionals), and any source of text data (e.g. reviews, tweets, comments, blog posts). FIGS. 2 and 3 are visualizations of an output of the same model extracting recommendations from two different verticals—mobile applications and venues, respectively.

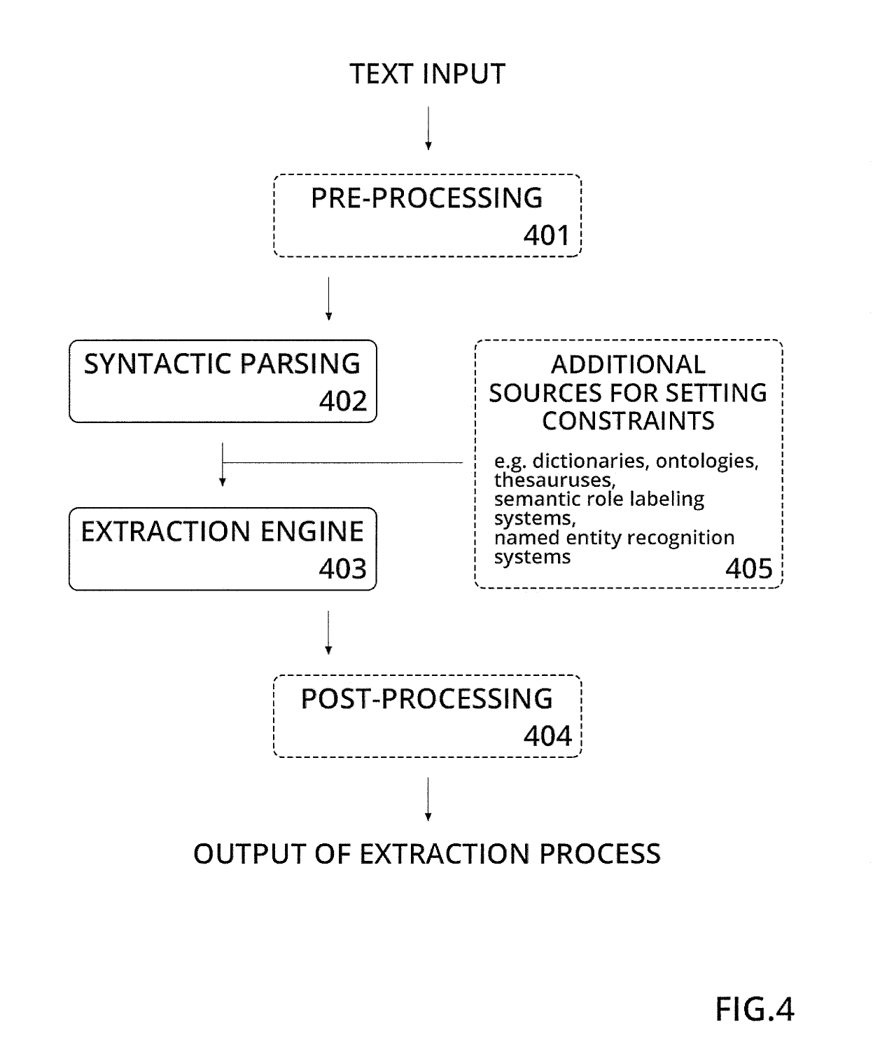

FIG. 4 is a block diagram of an extraction process according to an embodiment. First, text input is subject to pre-processing (401) comprising various operations such as preliminary filtering of text data, adding any meta-data about text input or any kind of text correction and normalization. Second, pre-processed text is processed with a syntactic parser (402) providing syntactic analysis of text input. Additional sources for setting constraints (405) may be applied at this stage. Parsed text with optional meta-data from pre-processing (401) and additional sources for setting constraints (405) is processed with extraction engine (403) which executes an extraction model or a set of extraction models on a given text data. Extracted results are subject to post-processing (404) comprising various operations such as clusterization, categorization or any kind of processing that modifies or enhances the extracted results in order to present the results of extraction process or provide the results of extraction process as an input for any other system and method. Only the syntactic parsing (402) and the use of extraction engine (403) are obligatory for the extraction process. The pre-processing (401), post-processing (404) and additional sources for setting constraints (405) are optional.

### Pre-Processing of Extraction Models

In order to raise the performance of extraction process (e.g. speed or accuracy), input text data can be pre-processed before executing extraction models. The embodiments disclosed herein are mainly described in terms of particular implementations. However, one of ordinary skill in the art will readily recognize that this method and system will operate effectively in other implementations. Furthermore, disclosed implementations can be applied either separately or jointly, in any effective combination.

In an embodiment, keyword filtering or any pattern matching is applied even before syntactic parsing to filter out texts or sentences that definitely do not contain answers for a given question. Although extraction models rely strongly on grammar structure, it is very common to use lists of words as additional constrains. These lists of words, if define obligatory conditions, can be used to perform the filtering, e.g. using regular expressions or string matching. For example, if one builds an extraction model to answer a question “what people want to buy” (declarations of the willingness of making a purchase), a subset of rules might contain a list of verbs that needs to match a predicate phrase. The list comprising of verbs like “buy”, “want”, “need”, “require” can be used directly to build a regular expression to filter out all sentences that do not contain any verb from the list. If a subset of rules contains more solid keyword-related conditions, it is possible to build more complex patterns in order to make pre-processing more effective.

In other embodiment, any system and method providing meta-data about input text data as another source for setting constraints (building rules) are applied. These systems and methods includes (but not limited to):
dictionaries;
ontologies;
thesauruses;
semantic role labeling;
named entity recognition;
word sense disambiguation;
word and phrase embedding;
co-reference and anaphora resolution.

Assigned meta-data are used in the process of building rules to set additional constraints other than constraints on grammar structure. For example, a set of rules can be an arbitrary implementation of following exemplary constraints using assigned meta-data:
phrase X must be a name of the drug;
phrase Y must be a person or organization;
phrase Z must be a synonym of word “place”.

In other embodiment, any system and method for correction or normalization of input text data are applied. An example of using correction is a spelling correction (e.g. typos) in user generated content when syntactic parser is not able to handle this kind of errors. Another example is a correction of input text data provided using OCR or speech-to-text systems. An example of using normalization is any form of listing or enumerating normalization. Another example is a normalization of special characters, character references (e.g. “&#278;”, “&and;”) and tags (e.g. HTML tags such as “<br />”).

### Post-Processing of Extraction Models

In order to present the results of extraction process or provide the results of extraction process as an input for any other system and method, the results of extraction process can be post-processed after executing extraction models. The embodiments disclosed herein are mainly described in terms of particular implementations. However, one of ordinary skill in the art will readily recognize that this method and system will operate effectively in other implementations.

Furthermore, disclosed implementations can be applied either separately or jointly, in any effective combination.

In an embodiment, the semantically similar parts of the results of extraction process are grouped together under a representative label that fits in all grouped results. For example, an extraction model that answers a question “what a product or service help with” can extract following results:
helps me|grow plants;
helping me|growing herbs;
helps|to crop plants;
support|growing herbs.

If it is desired to not distinguish “support” from “help” and “herbs” from “plants”, all of above results can be grouped under common representatives (e.g. “helps me” and “grow plants” respectively). The process of selecting a representative can be performed automatically, semi-automatically or manually.

In other embodiment, a categorization of previously extracted results is performed. For example, an extraction model that answers a question “what people complain about” can extract following results:
hotel manager;
front desk assistance;
staff.

The subset of the results can be categorized into “service” category. The process of defining categories can be performed automatically, semi-automatically or manually.

In other embodiment, the results are organized into taxonomy and categorized into one or more levels of hierarchical categories, e.g. an extracted word or phrase “roses” can be categorized as:
flower, which is a subcategory of
plant, which is a subcategory of
nature.

In other embodiment, post-processing does not consist of grouping of the results of extraction process. Instead, post-processing realizes a model-specific co-reference resolution in order to replace pronouns in extracted results with related words, phrases or clauses. For every pronoun, a set of potential candidates is extracted and then every candidate is validated against a large set of extracted results for this extraction model in order to choose the best fit. For example, if a pronoun “them” appears as a reason for deleting an app, a large set of extracted results for this extraction model contains a large number of deleting reasons for every processed text data for every app. Extracted candidates are validated against this set of extracted results in order to find which candidates appear as a deleting reason in other cases. Based on this validation, the best candidate is chosen as a replacement. This method very often turns out to be more accurate than general co-reference resolution methods applied in pre-processing as a source of meta-data.

The embodiments disclosed herein comprise mainly categorization and clusterization methods for post-processing. However, post-processing comprises any kind of transformation of information that can be performed on the results of extraction process, including any form of combining or correlating the results from two or more extraction models. Post-processing can be performed using various approaches, including (but not limited to):
statistical, e.g. deep learning and machine learning;
symbolic, e.g. rule-based;
manual, e.g. crowdsourcing.

Any of those approaches can be supported with various resources, systems and methods, including (but not limited to):
labeled or unlabeled text corpora;
lexical databases, e.g. WordNet;
knowledge bases and ontologies, e.g. Google's Knowledge Graph, OpenCyc, DBpedia, GeoNames, YAGO.

### Process and Methodology of Building Extraction Models

A process of building an extraction model starts with a question asked to a corpus of text data. There are no limitations for questions to be asked. However, answering some specific questions, aside from a regular extraction, might require an additional processing of the results of extraction process. For example, answering a question “what are top 10 reported problems” requires an extraction of reported problems, presumably a clusterization of those problems and a sorting of those problems by a number of occurrences in order to find 10 problem with the highest occurrence rate.

Furthermore, answers for a general question can be a sum of answers for a set of questions. For example, a question “what should I change in my product” can be seen as a set of questions such as “what should I fix in my product”, “what should I add to my product”, “what should I remove from my product”, etc. And vice versa, a specific set of rules that extracts reasons expressed in text data can serve as a sub-model for a number of specific questions, e.g. “why do people download my app”, “why do people delete my app” or “what are the reasons for changing one product to another.”

A set of rules that performs a specific task but does not form yet an extraction model can be organized and saved as a reusable definition (or function). For example, a set of rules that verifies if examined clause is not related in any way to a contrafactual clause forms one of the most reusable definition. A contrafactual clause is a clause that negates in any way a fact or a set of facts expressed in an examined clause, e.g. “I don't think the Apple Watch integration should be added.” This definition used in a model that extracts answers for a question “what should I add to my product” prevents a system from extracting “the Apple Watch integration” in above example.

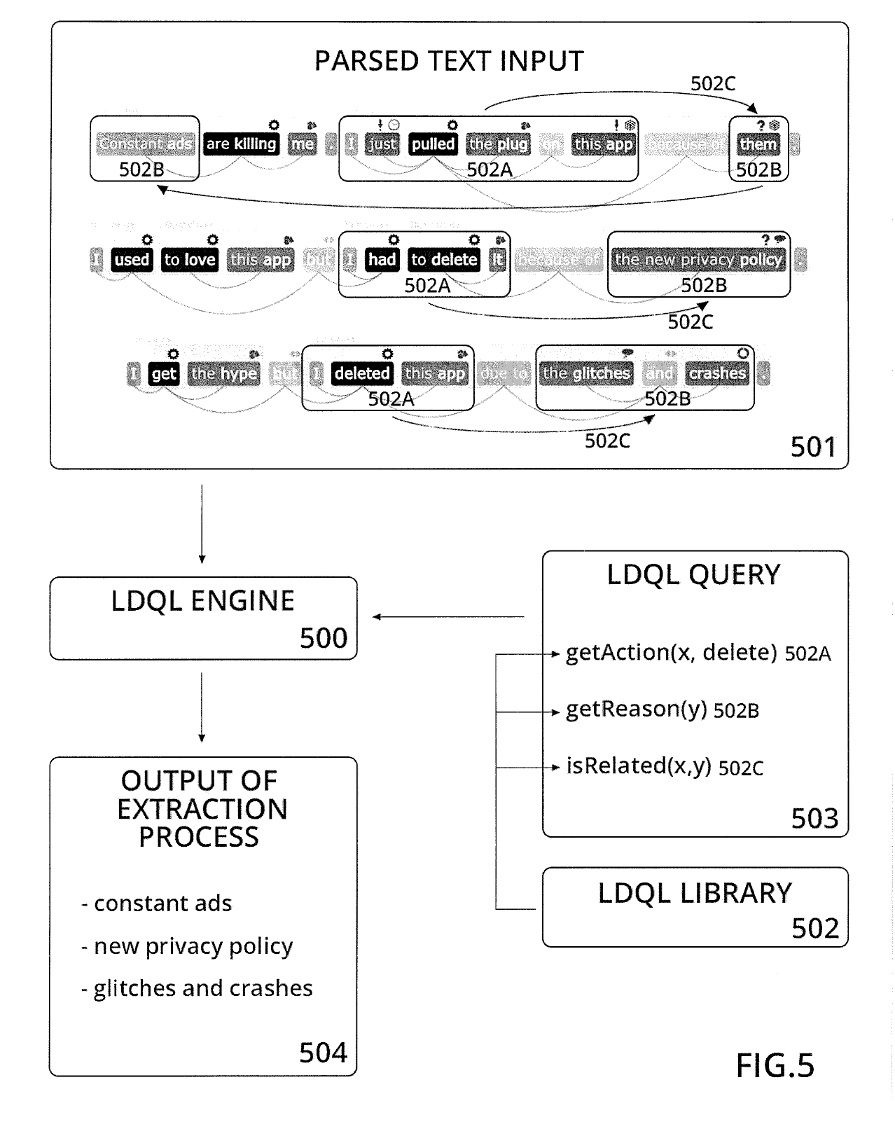

Reusable definitions form libraries and allow to build extraction models from blocks rather than from scratch. FIG. 5 shows a simplified example of building an extraction model (503) that answers a question “why do people delete an app” from reusable functions from the library (502). First, the function extracting actions (502A) is used with a parameter (or a macro) that narrows down the extraction to actions of deleting. Second, the function extracting reasons (502B) is used and finally the function that verifies if an action of deleting and a reason are related (502C) is used. Once the extraction model (503) is built, text data is processed by syntactic parser (Language Decoder in an embodiment) (501), the model is executed by extraction engine (Language Decoder Query Language in an embodiment) (500) and the results are extracted as the output of extraction process (504).

The capability to form reusable definitions realizing specific tasks and to organize them into easily accessible libraries is an enabling factor that allows the person having ordinary skill in the art to assemble previously prepared definitions in order to build an accurate extraction model.

In an embodiment, LDQL Hatchery is used as a complex environment for building, maintaining and managing rules, definitions and models, and organizing them into libraries. LDQL Hatchery allows teams of LDQL coders to cooperate by providing them options for sharing rules, definitions and models between different projects and users. LDQL Hatchery allows to test and debug rules, definition and models by highlighting errors in LDQL syntax, tracking rule-by-rule a process of execution rules, definitions and models, and providing basic extraction-related data such as number of extracted results or time of extraction process. LDQL Hatchery allows to run a simulation of rules, definitions and models on arbitrary set of text data in order to see the results of extraction process for this data set. The set of text data can be previously labeled by a testing team in order to perform automatic measurement of the performance of extraction process (e.g. using precision, recall and F-score metrics). LDQL Hatchery allows to define and use pre-processing and post-processing methods on the results of extraction process. Furthermore, LDQL Hatchery allows for automatic API generation for an extraction model or a set of extraction models. Typically, a generated API takes a text or a set of texts as an input and delivers the results of extraction process as an output.

The embodiment disclosed herein use LDQL Hatchery as an environment for building, maintaining and managing rules, definitions and models, and organizing them into libraries.

However, any other system that realizes an arbitrary subset of LDQL Hatchery functionalities or comprises any extension of those functionalities can be used as such environment.

In an embodiment, rules are hand coded. First, an engineer defines an output structure based on an asked question, i.e. how many columns and which types of units or combinations of units within a grammar hierarchy form an output structure. Furthermore, names of columns comprising an output structure and names of variables related to these units or combination of units can be given. In LDQL, an output structure is defined within a SELECT section. An exemplary SELECT section:

SELECT

P:object AS OBJECT,

P:opinion AS OPINION

In above example, the output of extraction process comprises two columns. First column is labeled as OBJECT, and contains a phrase, represented with a variable name “object.” Second column is labeled as OPINION, and contains a phrase, represented with a variable name “opinion.”

Second, an engineer sets constraints on defined output structure, using rules and definitions. In LDQL, constraints are set withing a WHERE section. An exemplary WHERE section: WHERE

object.phrase-type=‘subject’

AND opinion.phrase-type=‘complement’

AND exists-linking-verb(object, opinion)

AND contains-evaluative-adjective(opinion)

AND NOT has-component(opinion, ‘core’)

In above example, first two lines after WHERE tag define types of “object” and “opinion” phrases as “subject” and “complement”, respectively. Next three lines use definitions to set additional constraints on output structure. A definition “exists-linking-verb” verifies if its arguments are related to each other by a linking very (e.g. “be”, “taste”, “smell”). A definition “contains-evaluative-adjective” verifies if its argument contains an evaluative adjective (e.g. “good”, “bad”, “awful”). A definition “has-component” verifies if its first argument contains a word which type is defined as “core.”

The whole exemplary model, although very simple, extracts therefore objects and related opinions from sentences of the following grammar constructions: “the vibe is relaxing”, “the duck tastes great”, etc. The embodiment disclosed herein comprises LDQL syntax as a way of formulating rules. However, any formal language that allows to set similar types of constraints can be used instead.

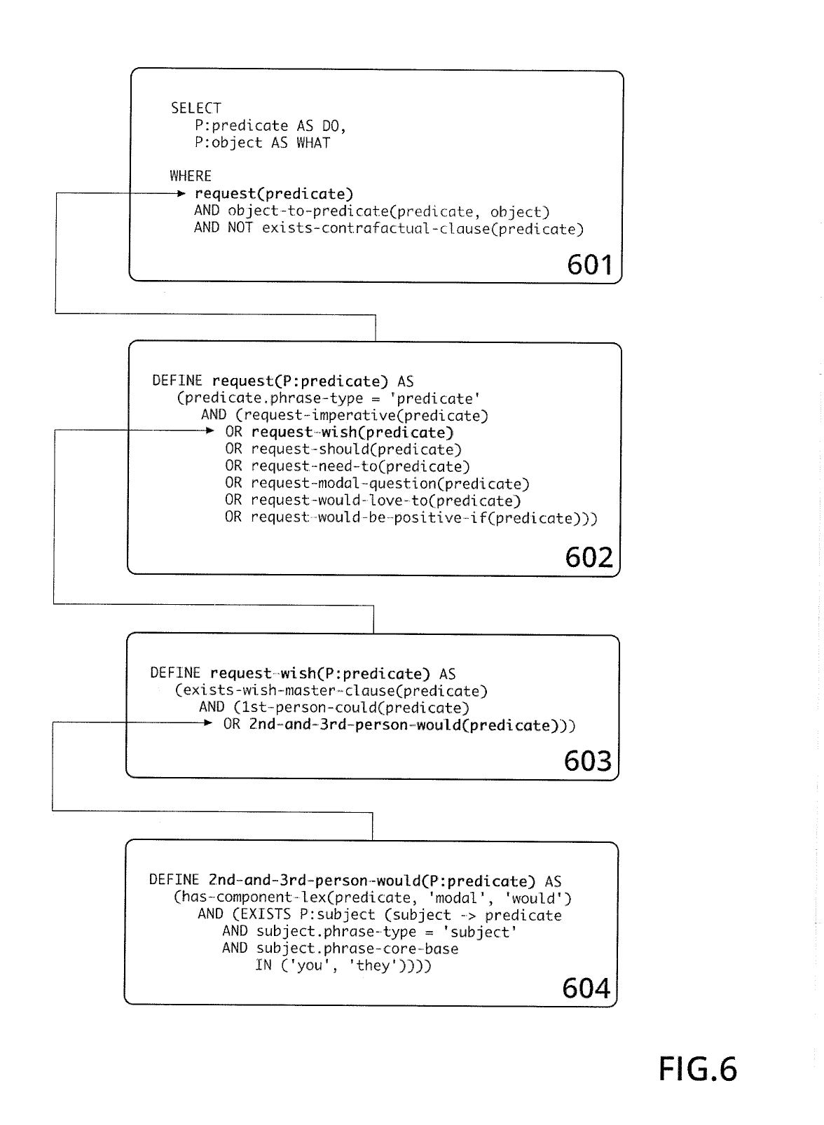

FIG. 6 illustrates a more complex example of assembling definitions in order to build an extraction model. The model (601) extracts user requests in a form of an action (DO) and an object of the action (WHAT). For example, from a sentence “I wish they would provide more detailed data usage.”, after post-processing, the model (601) would extract a pair “add” (DO) and “more detailed data usage” (WHAT). The model (601) comprises a set of definitions. One of them is a “request” definition (602) comprising various constructions used to express a request. Every such construction was coded as a separate definition. A “request-wish” definition (603) is responsible for capturing the constructions using “wish” in order to express a request such as “I wish I could . . . ” or “I wish you would . . . ” Lastly, a definition “2nd-and-3rd-person-would” (604) is a simple low-level definition responsible for capturing the constructions where a predicate contains a modal verb “would” and there is a subject “you” or “they” connected to the predicate.

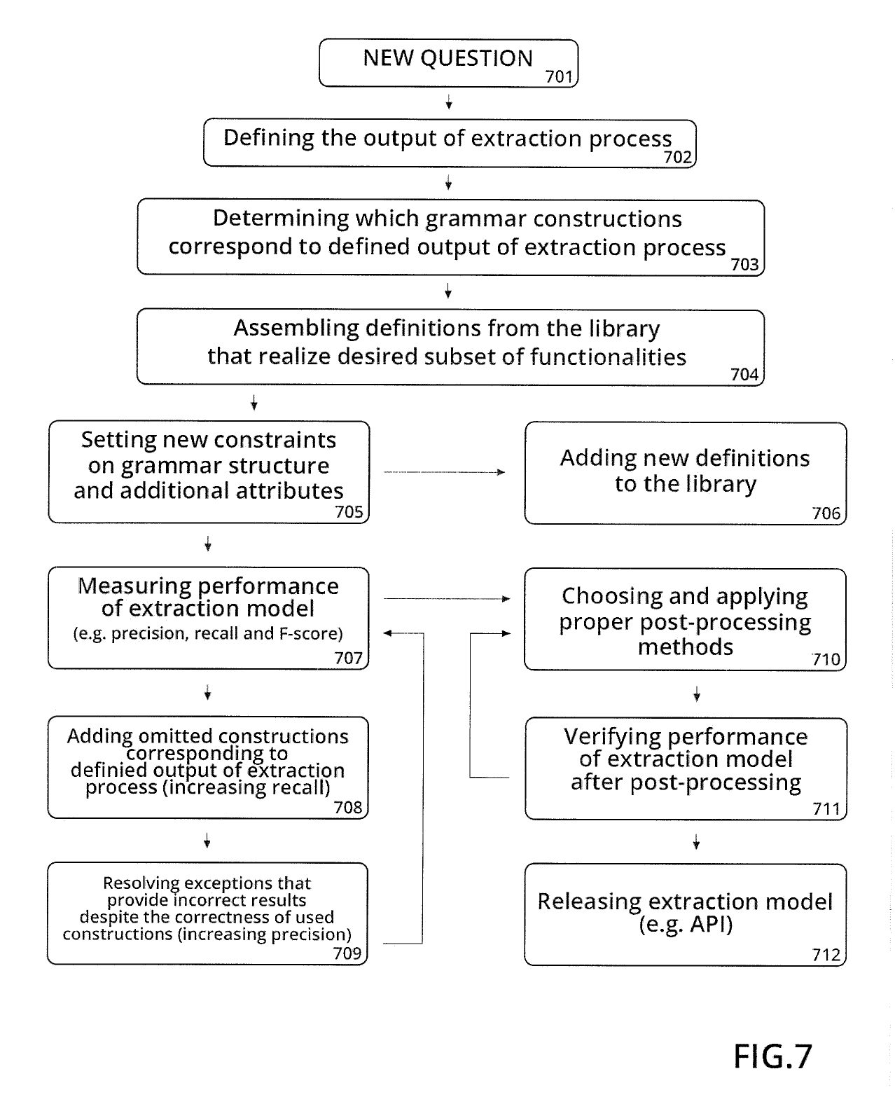

FIG. 7 is a flow diagram illustrating a process of building an extraction model for a new question. A new question 701 is entered, and the system then defones the output pof the extraction process (702). It is determined which grammar construction corresponds to the defined output of the extraction process (703). Definitions that realize the desired subset of functionalities are assembled from the library at 704.

New constraints are then set on the grammar structure and additional attributes (705). Using the results from 705, new definitions are added to the library (706), and the performance of the extraction model is measured (707). Based on 707, a proper post-processing method or methods are chosen and applied (710). Also, using the results of 707, omitted constructions corresponding to the defined output of the extraction process are added (708). Then exceptions are resolved (709), and performance is measured again (707).

Using the results of 710, the performance of the extraction model is verified (711), and then the extraction model is released (712).

In other embodiment, rules are built automatically or semi-automatically, based on an existing model, a set of results of extraction process using this model and a parsed corpus of text data. A deep or machine learning model is trained to find new constructions providing answers for a given question based on previously extracted results, create new rules describing these constructions and therefore develop the model. In semi-automatic approach, human supervisor can verify created candidates and choose the best ones. The process can also comprise reinforced learning techniques where creating a good rule is rewarded. Additionally, this approach can be supported by providing a set of labeled data. A deep or machine learning model is then used to find new constructions matching labeled data.

The embodiments disclosed herein comprise manual methods for building the extraction models with automatic and semi-automatic methods for the further development of the extraction models. However, one of ordinary skill in the art will readily recognize that these methods can be enhanced in many ways with other automatic and semi-automatic systems and methods. For example, extrapolating the case of using labeled data to develop an extraction model can result in an automatic or semi-automatic method for building definitions and models from scratch, not only as a method for developing existing definitions and models.

### Usage of Extraction Models

The system and method for information extraction disclosed herein allow to build systems and applications in many areas, including (but not limited to):
chat bots and dialog systems;
text analytics;
big data analytics;
predictive analytics;
business intelligence;
competitive intelligence;
search engines;
recommendation engines;
customer service automation;
marketing automation;
any systems and applications that support a decision-making process;
any systems and applications that automate a decision-making process.

The system and method for information extraction disclosed herein allow to build systems and applications in many verticals, including (but not limited to):
retail (including e-commerce);
entertainment;
education;
mass media;
healthcare;
real estates;
legal services;
financial services;
hospitality & travel;
fast-moving consumer goods (FMCG).

The system and method for information extraction disclosed herein allow to process any type of text data, including (but not limited to):
user reviews, opinions, tips;
forum threads, posts;
blog posts, articles;
news, articles, publications;
tweets and any other microblog content;
expert reviews, articles, blogs;
comments, e.g. YouTube, Facebook;
emails and any equivalents of emails;
research papers, e.g. thesis, dissertation;
literature, e.g. novels, dramas, diaries, short stories;
any text messages, e.g. SMS, iMessage, WhatsApp, WeChat, Skype;
any conversations. messages and logs from collaboration tools, e.g. Slack;
CRM notes;
call center logs;
customer service logs;
tickets (issue tracking systems);
any handwritten and printed texts after OCR processing;
any audio and video recordings after speech-to-text processing;
any medical texts, documents, notes (e.g. doctor-patient notes and records);
any legal texts, documents, notes (e.g. contracts, patents, transcripts);
any conversations between people (e.g. written records of conversation);
any conversations between people and machines (e.g. chat bot logs);
any text data (and any other data that can be transformed into text data).

According to the fact that the system and method disclosed herein allow to extract actionable answers for given questions in a domain- and source-agnostic way, the system and method comprise a foundation for building an analytic platform providing answers for a set of common questions regarding products and services, and others, including (but not limited to): persons (e.g. politics, celebrities), organizations (e.g. companies, political parties), places for living and traveling, scientific papers, patents. A platform providing answers regarding products and services can be seen as a competitive intelligence platform for marketing and brand managers or product and business development. An exemplary set of common questions regarding products and services comprises:
Why do people change a product or service to another?
What should be changed in a product or service?
What should be fixed in a product or service?
What should be added to a product or service?
What should be removed from a product or service?
Why do people stop using a product or service?
Why do people start using a product or service?
What kind of problems do people have using a product or service?
How do people recommend a product or service?
How do people compare products or services in a given category?

According to the fact that the system and method disclosed herein allow to extract actionable answers for given questions without the necessity of training and labeling of data in order to build an extraction model, the system and method comprise an opportunity for building an on-premise solution able to process and make use of enterprise internal data such as emails, tickets, surveys, call center logs, CRM notes, etc. For example, a model extracting reported problems from text data, combined with a syntactic parser and a system for executing this model, can be used to automatically extract reported customer problems from enterprise call center logs.

According to the fact that the system and method disclosed herein provide the capability to form reusable definitions realizing specific tasks, to organize them into easily accessible libraries, and therefore to build extraction model by assembling these definitions rather than building them from scratch, the system and method comprise an opportunity for building an open platform for building and sharing rules and definitions among a broad community. This opportunity is a straight-forward development of the LDQL Hatchery environment disclosed herein. Although currently LDQL Hatchery comprise an internal environment for building, maintaining and managing rules, definitions and models, and organizing them into libraries, it can be further developed and ultimately open to a broad community of people without deep linguistic knowledge, allowing them to build accurate extraction models for various purposes.

According to the fact that the system and method disclosed herein provide the capability to build a broad knowledge base from various sources across various verticals, the system and method comprise an opportunity for building a backbone for a chat bot ecosystem. A business-facing chat bot opportunity comprises a virtual expert providing actionable answers based on knowledge extracted from both publicly available data and enterprise internal data. Combining and correlating the extracted knowledge with structured data (e.g. demographics, sales statistics) allows to answer critical business questions such as “what are top reasons for choosing us over the competition from the last month.” A consumer-facing chat bot opportunity comprises a virtual adviser helping to make decisions and solving the paradox of choice based on knowledge extracted from other people opinions, reviews, forums, tweets, expert blog posts, etc. Combining and correlating the extracted knowledge with behavioral data (e.g. personal preferences, collaborative filtering) allows to provide a conversational interface for finding products and services based on fulfilled expectations of other users rather than star ratings and other classification methods.

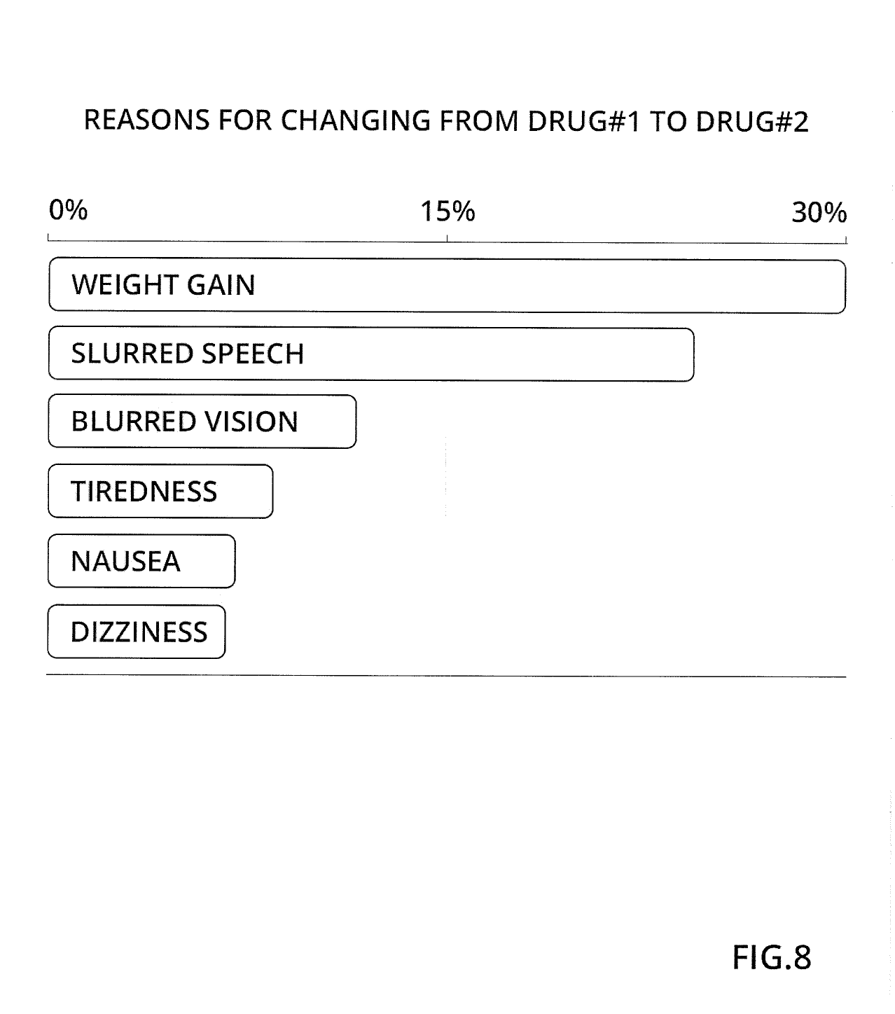

FIG. 8 is a visualization of an output of an extraction model built for an application for pharmaceutical industry. In this example, the extraction model answers a question “why do people change one drug to another.” The extracted reasons are presented using a bar chart showing the percentage of certain reasons among all extracted reasons. This is an example of the crucial questions allowing marketing and product managers to understand the reasons behind certain behaviors and use this knowledge in many areas of their work, e.g. to optimize marketing strategy.

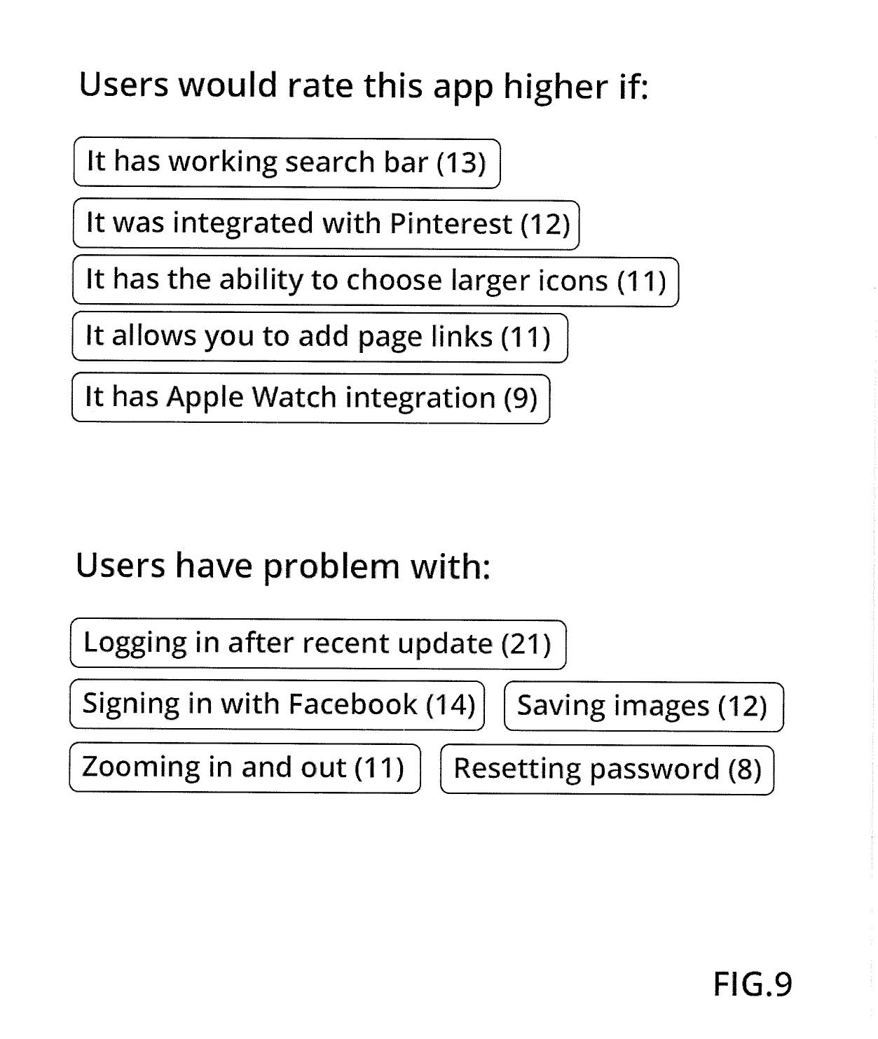

FIG. 9 is a visualization of an output of extraction models built for app analytics application. In this example, first extraction model answers a question “what should be done in an app in order to get higher rating”, whereas second model answers a question “what kind of problems users have using an app.” Both models provide product managers (and other decision makers) with actionable answers regarding the future development of their products. First model not only tells what is missing or does not work properly, but also defines it as a direct reason for giving a lower rating.

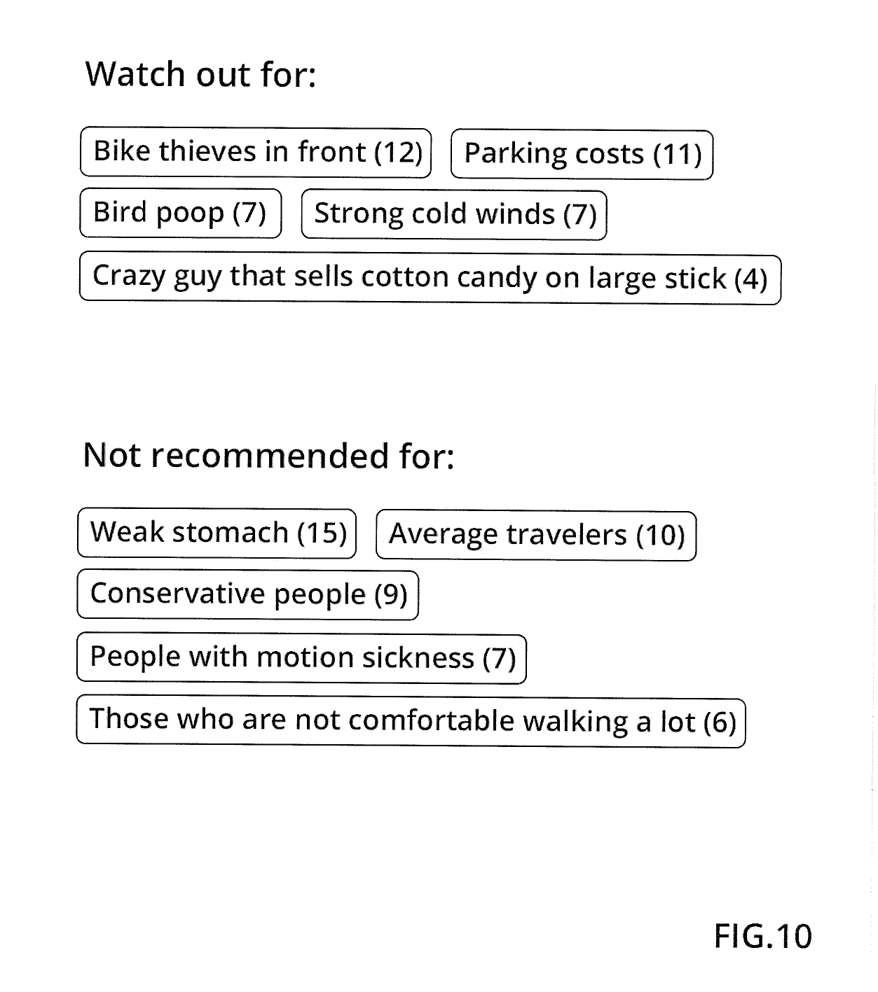

FIG. 10 is a visualization of an output of extraction models built for hospitality and travel application. In this example, first extraction model answers a question “what a visitor should watch out for at this place”, whereas second model answers a question “what kind of people should avoid this place.” Both models provide a potential visitor with useful hints and warnings. For example, first model warns against leaving a bike in the front, whereas second model warns that conservative visitors may not feel comfortable in this place.

With reference to FIG. 8-10, after clicking on labeled box (e.g. “weight gain”, “parking costs”, “saving images”), the corresponding application displays the source text data (e.g. full review) of extracted results with highlighted fragments where each result comes from.

What is claimed is:

1. A system for natural language processing (NLP) utilizing one or more extraction models and an output of syntactic parser applied to a text to extract information from this text:
wherein an extraction model defines one or more units or combinations of units within a grammar hierarchy (a word, a phase, a clause, or any combination of words, phrases and clauses) as an output of extraction process; and
wherein an extraction model comprises a set of rules where every single rule sets one or more constraints on the grammar structure, i.e. on the output of extraction process, on the context of the output of extraction process, and on the relations between the output and the context:
wherein given constraints jointly reflect a set of grammar constructions used for expressing specific intents and experiences;
wherein the context consists of all units and combinations of units within a grammar hierarchy other than the output of extraction process, and all relations between these units and combinations of units; and
wherein the rules comprising an extraction model are connected by logical operators such as AND, OR, XOR, NOT, or a combination of logical operators determining logical relations between the constraints.

2. The system of claim 1, wherein additional sources for setting constraints comprising logical and linguistic attributes other than syntactic structure are used.

3. The system of claim 1, wherein a pre-processing is performed before syntactic parsing or before executing extraction models in order to raise the performance of extraction process, wherein the pre-processing comprises any kind of transformation of information that can be performed on the input text data or on the syntactically parsed input text data.

4. The system of claim 3, wherein a keyword filtering or a pattern matching is applied before syntactic parsing or before executing extraction models in order to prevent the system from processing a text or a part of text that definitely will not return any results.

5. The system of claim 3, wherein meta-data about input text data as another source for setting constraints and building rules is provided.

6. The system of claim 3, wherein a correction or a normalization of input text data is applied.

7. The system of claim 1, wherein a post-processing is performed on a set of results extracted with one or more extraction models in order to present the results of extraction process or provide the results of extraction process as an input for any other system and method, wherein the post-processing comprises any kind of transformation of information that can be performed on the results of extraction process.

8. The system of claim 7, wherein the similar parts of the results of extraction process are grouped (clustered) together under a representative label that fits in all grouped (clustered) results.

9. The system of claim 7, wherein the similar parts of the results of extraction process are categorized into a set of predefined categories.

10. The system of claim 9, wherein the categories are organized in a hierarchy of levels.

11. The system of claim 7, wherein a model-specific co-reference resolution is realized in order to replace pronouns in extracted results with related words, phrases or clauses, wherein every potential candidate is extracted and validated against a set of extracted results for an extraction model in order to choose the best fit.

12. The system of claim 1, wherein a set of rules realizing a specific task is generalized, organized and stored as a reusable definition (function), wherein a definition (function) takes one or more arguments related to units within a grammar hierarchy and validates if a given set of arguments fulfills a coded set of constraints.

13. The system of claim 12, wherein an extraction model is assembled from previously coded definitions (functions) realizing specific sub-tasks of the whole extraction task.

14. The system of claim 12, wherein the rules, definitions and models are built, stored, maintained, managed and organized into libraries within a dedicated environment comprising one or more functionalities:
allowing to test and debug rules, definition and models;
allowing to share rules, definitions and models between different projects and users;
allowing to execute rules, definitions and models on an arbitrary set of text data in order to see the results of extraction process for a given data set;
allowing to define and use pre-processing and post-processing methods on the results of extraction process; and
allowing to automatically generate an API realizing an extraction model or a set of extraction models.
